(19) United States
(12) Patent Application Publication
(10) Pub. No.: US 2017/0186208 A1
(43) Pub. Date: Jun. 29, 2017

(54) 3D SURFACE MORPHING METHOD BASED ON CONFORMAL PARAMETERIZATION

(71) Applicant: SHING-TUNG YAU, Cambridge, MA (US)

(72) Inventors: Chin-Tien Wu, Hsinchu County (TW); Wei-Shou Su, Tainan City (TW); Mei-Heng Yueh, Hsinchu City (TW); Wen-Wei Lin, Taipei City (TW); Shing-Tung Yau, Cambridge, MA (US)

(21) Appl. No.: 14/980,236

(22) Filed: Dec. 28, 2015

(51) Int. Cl. G06T 13/40; G06K 9/62; G06K 9/00; G06T 15/00

(52) U.S. Cl. CPC G06T 13/40; G06T 15/005; G06K 9/6201; G06K 9/00268; G06K 9/00302; G06T 2200/04

(57) ABSTRACT

A 3D surface morphing method based on conformal parameterization for creation of 3D animation of facial expressions is revealed. Prepare a 3-dimensional first human face and a 3-dimensional second human face. Prepare a first unit disk and a second unit disk in a two-dimensional surface form, corresponding to the first human face and the second human face respectively. Then use a first mapping unit to map the first human face and the second human face to the first unit disk and the second unit disk respectively. Use a matching module to construct a surface matching function between the two unit disks. Use a second mapping module to map the surface matching function for getting a 3D matching function. Use an interpolation module to compute the 3D matching function multiple times and get a plurality of smooth deformable surfaces between the first human face and the second human face.

### BACKGROUND OF THE INVENTION

Field of the invention

The present invention relates to a 3-dimensional (3D) surface morphing method based on conformal parameterization, especially to a 3D surface morphing method applied to create 3D animation of facial expressions and obtaining a plurality of 3D smooth deformable surfaces by one-to-one and onto Riemann mapping, spline matching that constructs a surface matching function, cubic spline homotopy applied to a time variable of each deformation of a surface, and computation of the surface matching function. The present invention provides a novel 3D morphing technique.

### Descriptions of Related Art

The metamorphosis between two objects is commonly called a morphing. It is the process of changing one figure into another. In recent years, image morphing techniques have been widely used in the entertainment industry. Many techniques have been developed to achieve a desired morphing effect. Although 2-dimensional (2D) image morphing technique has pretty mature, 3D image morphing remains challenges, especially when the virtual real morphing effects are desired. In addition, in order to achieve a satisfactory visual effect, the texture images also need to be computed in the process of visualization.

On the other hand, with the advance of the three dimensional imaging technology, surface morphing in 3D has become very important. Comparing to the 2D image matching problem, surface matching problem is much more difficult, since the surface matching involves the correspondence in R³ coordinates and the geometric information of images in R³ is far richer than images in 2D.

### SUMMARY OF THE INVENTION

In order to overcome the above problems, there is room for improvement and a need to provide a novel method.

Therefore it is a primary object of the present invention to provide a 3D surface morphing method based on conformal parameterization to create 3D animation of facial expressions, which creates 3D smooth deformable surfaces by one-to-one and onto Riemann mapping, spline matching that constructs a surface matching function, cubic spline homotopy applied to a time variable of each deformation of a surface, and computation of the surface matching function. The method provides a novel 3D morphing technique.

In order to achieve the above object, a 3D surface morphing method based on conformal parameterization for creation of 3D animation of facial expressions of the present invention including the following steps is provided. Firstly prepare a 3-dimensional first human face and a 3-dimensional second human face. Then prepare a first unit disk and a second unit disk corresponding to the first human face and the second human face respectively. Both the first unit disk and the second unit disk are in a two-dimensional surface form. Next use a first mapping unit to map the first human face and the second human face to the first unit disk and the second unit disk respectively. Then use a matching module to construct a surface matching function between the first unit disk and the second unit disk. Use a second mapping module to map the surface matching function for getting a 3D matching function which shows the correspondence between the first human face and the second human face. Lastly use an interpolation module to compute the 3D matching function multiple times for getting a plurality of smooth deformable surfaces between the first human face and the second human face.

The first mapping unit maps the first human face and the second human face to the first unit disk and the second unit disk respectively by Riemann mapping.

The matching module constructs the surface matching function between the first unit disk and the second unit disk by using spline matching.

The second mapping module takes the mapping in an inverse way compared to the first mapping module. Thus the surface matching function is inversely mapped to get the 3D matching function between the first human face and the second human face by the second mapping module.

The interpolation module gets a plurality of smooth deformable surfaces between the first human face and the second human face by using cubic spline homotopy.

The cubic spline homotopy is the application of cubic spline interpolation to a time variable of each deformation of the first human face and the second human face.

Thereby the 3D surface morphing method of the present invention gets 3D smooth deformable surfaces effectively by one-to-one and onto Riemann mapping, spline matching that constructs a surface matching function, cubic spline homotopy applied to a time variable of each deformation of a surface, and computation of the surface matching function. Moreover, the present method avoids problems of multiple mapping and surface overlapping during the morphing process and constructs a 3D surface matching function by one-to-one and onto Riemann mapping. Lastly, the present method uses cubic spline homotopy that applies cubic spline interpolation to a time variable of each deformation of the surface to ensure smooth and natural transformation during the 3D morphing process and generate a plurality of smooth deformable surfaces for creating 3D animation of facial expressions.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart showing steps of a 3D surface morphing method based on conformal parameterization according to the present invention;

FIG. 2 is an idea for computing Riemann mapping according to the present invention;

FIG. 3 shows two different facial expressions and the associated conformal mappings according to the present invention;

FIG. 4 is a partition mesh of the unit disk for different facial expressions according to the present invention;

FIG. 5 is a cubic spline homotopy of the mean curvature and conformal factor of a vertex according to the present invention.

### DETAILED DESCRIPTION OF THE PREFERRED EMBODIMENT

In order to learn functions and features of the present invention, please refer to the following embodiments with detailed descriptions and the figures.

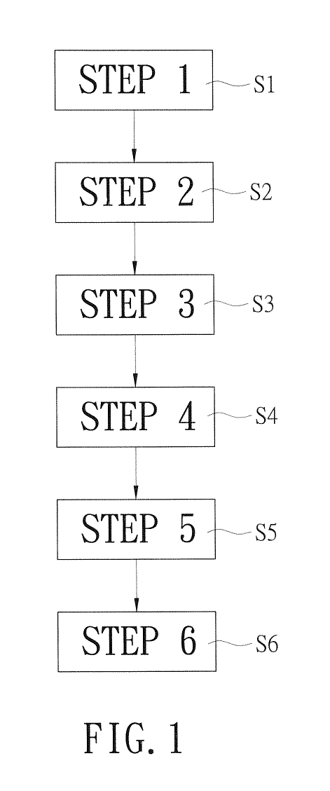

Refer to FIG. 1, a 3D surface morphing method based on conformal parameterization for creation of 3D animation of facial expressions includes the following steps.

Step 1 (S1): prepare a first 3-dimensional human face and a second 3-dimensional human face.

Step 2 (S2): prepare a first unit disk and a second unit disk corresponding to the first human face and the second human face respectively; the first unit disk and a second unit disk are in a two-dimensional surface form.

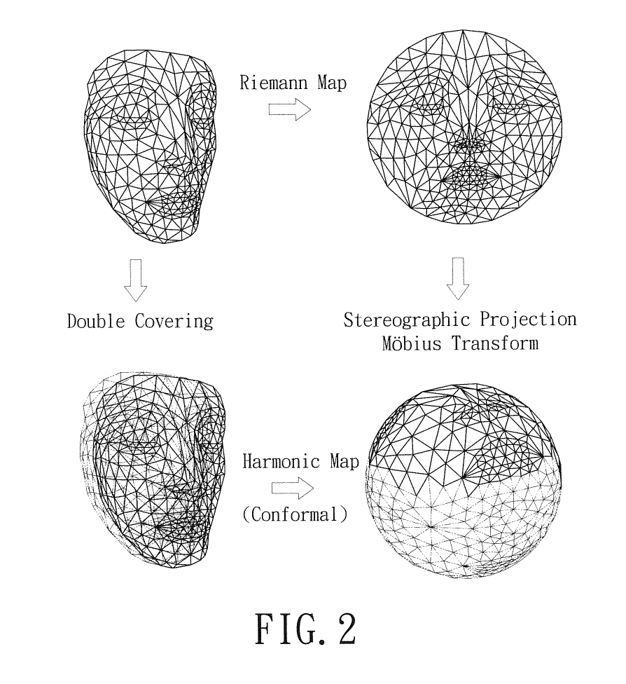

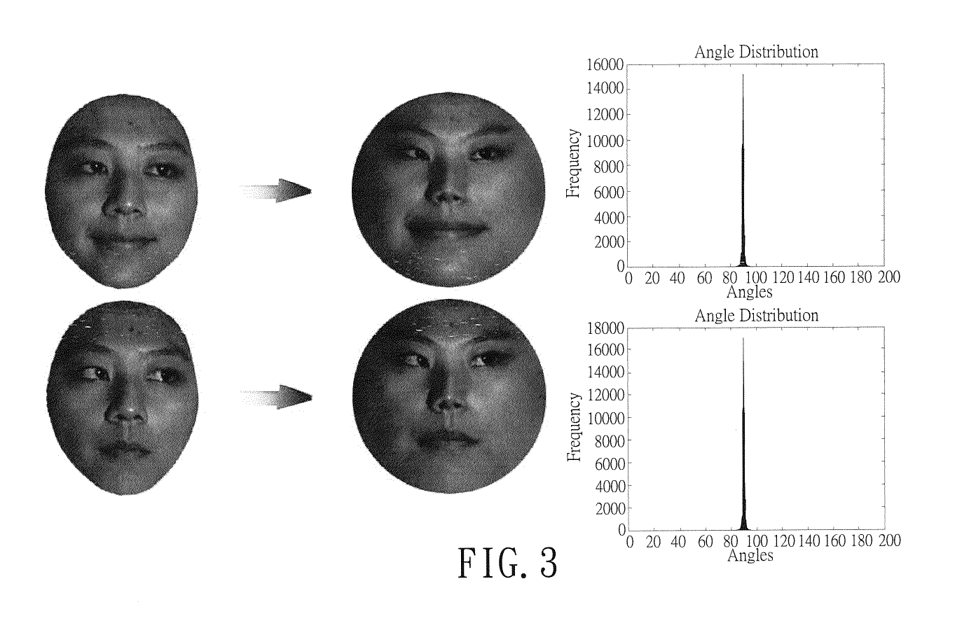

Step 3 (S3): use a first mapping unit to map the first human face and the second human face to the first unit disk and the second unit disk respectively. Each human face is mapped to the corresponding unit disk by Riemann mapping. Refer to FIG. 2, an idea for computing Riemann mapping according to the present invention is revealed. The Riemann conformal mapping plays an important role in the surface matching, and the idea for computing Riemann conformal mapping was first proposed by Gu and Yau (Computational Conformal Geometry, Higher Education Process, 1 edition, in 2008). The robustness of the quasi-implicit Euler method (QIEM) by computing the Riemann conformal mapping of human facial expressions has been demonstrated. As shown in FIG. 3, a result of the Riemann conformal mapping according to the present invention, wherein two different facial expressions and the associated conformal mapping are shown. In order to check the conformality of the QIEM, a checkerboard grid is pasted on the image of the Riemann conformal mapping φ(M) and then is put back to the surface M by using the inverse of the Riemann conformal mapping φ⁻¹. If the mapping is angle-preserving, every angle should be nearly 90 degree, and the histograms of the angle distribution are shown in the FIG. 3. The comparison of the time cost of Gu-Yau and QIEM is shown in Table. 1 and the numerical results indicate that the QIEM is very efficient and accurate on angle preserving.

Step 4 (S4): use a matching module to construct a surface matching function between the first unit disk and the second unit disk. The matching module constructs the surface matching function between the first unit disk and the second unit disk by using spline matching. Surface mapping plays a critical role in surface morphing. When it comes to R³ surface matching, it would be much more difficult. However, the 3D surface matching problem can be reduced into the unit disk matching problem with the Riemann conformal mappings. Hence, a similar idea of the 2D landmark matching is applied to the 3D surface matching. In the following, a landmark of each facial expression by composition of a Möbius transformation and deformation from the plate matching is proposed. In the thin-plate model, a deformation field is approximated by the span of the Green functions r² log r of the bending operator at each grid point where r is the distance between cⱼ and x ε C. The matching function is defined by

$$\overline{f} ( {x}^{1} , {x}^{2} ) = ( {\overline{f}}^{1} ( {x}^{1} , {x}^{2} ) , {\overline{f}}^{2} ( {x}^{1} , {x}^{2} ) ) with x = ( {x}^{1} , {x}^{2} ) and$$

$${\overline{f}}^{k} ( {x}^{1} , {x}^{2} ) = {\sum }_{j = 1}^{{n}^{2}} ( {α}_{j}^{k} {‖ x - {c}_{j} ‖}^{2} log ‖ x - {c}_{j} ‖ ) + {\sum }_{j = 1}^{2} {γ}_{j}^{k} {x}^{j} + {γ}_{3}^{k} ,$$

for k=1, 2, where αⱼ^{k} and γⱼ^{k} are unknown coefficients. To determine these coefficients for matching landmarks on conformal parametric domain, the least square problem should be solved.

$$arg {min}_{{α}^{k} , {γ}^{k}} {‖ [ S \vert Q ] [ \frac{{α}^{k}}{{γ}^{k}} ] - {q}^{k} ‖}_{2} , k = 1 , 2 , \\ where {S}_{ij} = \frac{{λ}_{1 j}}{{λ}_{0 j}} {‖ {p}_{i} - {c}_{j} ‖}^{2} log ‖ {p}_{i} - {c}_{j} ‖ ,$$

i=1, . . . m, j=1, . . . , n², λ₀ⱼ and λᵢⱼ are the conformal factors, resulted from the Riemann conformal mappings φ₀ and φᵢ, at cⱼ, respectively, and

Q=└(pᵢ¹, pᵢ², 1)┘ᵢ₌₁^{m}, α^{k}=[α₁^{k}, . . . , αₙ_{²}^{k}]^{T},

γ^{k}=[γ₁^{k}, γ₂^{k}, γ₂^{k}]^{T}, q^{k}=[q₁^{k}, . . . , qₘ^{k}]^{T}.

Step 5 (S5): use a second mapping module to map the surface matching function for getting a 3D matching function that shows the correspondence between the first human face and the second human face. The second mapping module takes the mapping in an inverse way compared to the first mapping module. Thus the surface matching function is inversely mapped to get the 3D matching function between the first human face and the second human face by the second mapping module.

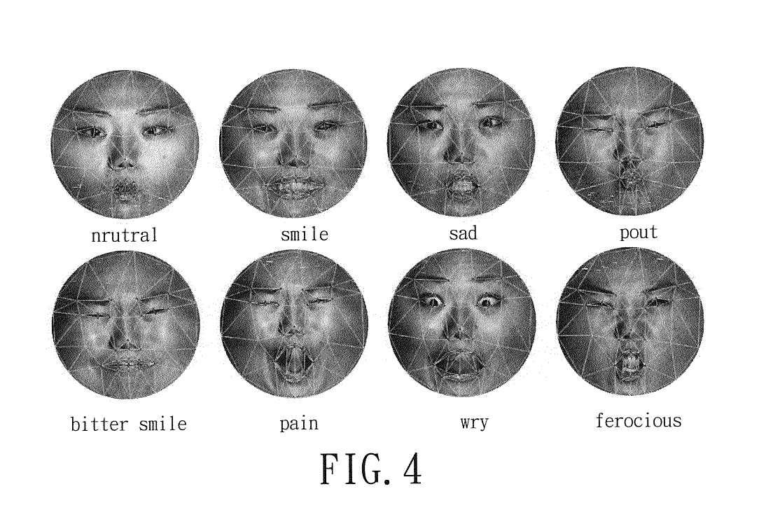

Step 6 (S6): use an interpolation module to compute the 3D matching function multiple times for obtaining a plurality of smooth deformable surfaces between the first human face and the second human face. The interpolation module gets these smooth deformable surfaces by using cubic spline homotopy that applies cubic spline interpolation to a time variable of each deformation of the first human face and the second human face. The effect of the traditional image morphing by using the direct interpolation is not satisfactory since the correspondence might be wrong. In 3D morphing, it could be even worse. To improve the phenomenon and the efficiency, the initial path is calculated by,
1. construct the frame on the unit disk, where feature points are connected by straight line segments.
2. the initial paths are obtained by taking the inverse conformal map φ−1 of these line segments.
3. apply Martinez's algorithm to obtain the geodesic frame.
   Refer to FIG. 4, a partition mesh of the unit disk for different facial expressions according to the present invention is revealed. The resulted geodesic frame is called as the single mesh. The initial paths in the frame mostly converge to the geodesics within 5 steps in the path correcting iterations. To build a one-to-one surface registration, the aforementioned partition mesh φ(M) is used. The surface registration method is utilized to generate the morphing sequence through the cubic spline homotopy of the mean curvatures and the conformal factors. Suppose 3D images of facial expressions S₀, S₁, . . . , S_{N}, are captured a time t₀, t₁, . . . , t_{N}. Using the surface registration method, the registration maps R_{φ}_{ᵢ}:Sᵢ₋₁→Sᵢ, i=1, 2, . . . , N, can be easily computed. Using these registration maps, a morphing path P(v,t), t ε[t₀, t_{N}] and v εS₀, can be created, here P(v,t) denotes the location where a point v εS₀ is morphed at time t. Since (H, λ) is a unique representation of a surface, the morphing path can also be uniquely determined by the evolution of the conformal factor and the mean curvature.

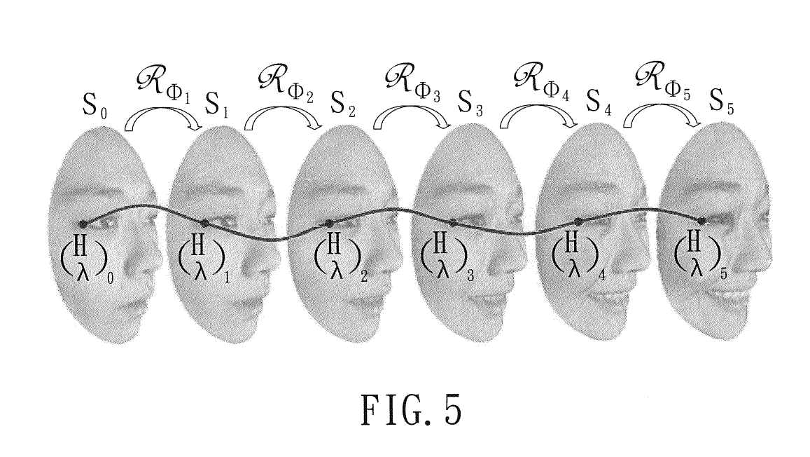

Refer to FIG. 5, a cubic spline homotopy of the mean curvature and conformal factor of a vertex according to the present invention is revealed while the detain algorithm can be seen in the following algorithm.

Input: A sequence of points {xₖ}ₖ₌₀^{N} and a partition of the time
interval [0, N],
P_{[0,N]} = {0 = t₀ < tᵢ < . . . < tₙ = N}.
Output: The sequence of points {xₜ_{ᵢ}}ᵢ₌₀ⁿ.

| 1 | for i = 0, 1, . . . , N − 1 do | | | |
|---|---|---|---|---|
| 2. | | Set hᵢ = tᵢ₊₁− tᵢ. | | |
| 3. | end for | | | |
| 4. | for i = 0, 1, . . . , N − 1 do | | | |
| 5. | | $Set {α}_{i} = \frac{3}{{h}_{i}} ( {x}_{i + 1} - {x}_{i} ) - \frac{3}{{h}_{i - 1}} ( {x}_{i} - {x}_{i - 1} ) .$ | | |
| 6. | end for | | | |
| 7. | Set l₀ = 1; μ₀ = 0; z₀ = 0. | | | |
| 8. | for i = 0, 1, . . . , N − 1 do | | | |
| 9. | | $Set {l}_{i} = 2 ( {t}_{i + 1} - {t}_{i - 1} ) - {h}_{i - 1} {μ}_{i - 1} ; {μ}_{i} = \frac{{h}_{i}}{{l}_{i}} ; {z}_{i} = \frac{{α}_{i} - {h}_{i - 1} {z}_{i - 1}}{{l}_{i}} .$ | | |
| 10. | end for | | | |
| 11. | Set l_{N} = 1; z_{N} = 0; c_{N} = 0. | | | |
| 12. | for j = N − 1, N − 2, . . . , 0 do | | | |
| 13. | | $\begin{matrix}Set {c}_{j} = {z}_{j} - {μ}_{j} {c}_{j + 1} ; {b}_{i} = \frac{{x}_{j + 1} - {x}_{j}}{{h}_{j}} - \frac{{h}_{j} ( {c}_{j + 1} + 2 {c}_{j} )}{3} ; \\ {d}_{i} = \frac{{c}_{j + 1} - {c}_{j}}{3 {h}_{j}} .\end{matrix}$ | | |
| 14. | End for | | | |
| 15. | for i = 1, 2, . . . , n do | | | |
| 16. | | for j = 1, 2, . . . , N do | | |
| 17. | | | if xⱼ ≦ xₜ_{ᵢ} ≦ xⱼ₊₁ then | |
| 18. | | | | Set xₜ_{ᵢ} = xⱼ+ bⱼ(tᵢ − tⱼ) + cⱼ(tᵢ − tⱼ)² + dⱼ(tᵢ − tⱼ)³. |

| | |
|---|---|
| 19. | end if |

| | |
|---|---|
| 20. | end for |

| | |
|---|---|
| 21. | end for |

In summary, the 3D surface morphing method based on conformal parameterization of the present invention has the following advantages compared with the techniques available now.

1. The present method obtains 3D smooth deformable surfaces by one-to-one and onto Riemann mapping, spline matching used to construct a surface matching function, cubic spline homotopy applied to a time variable of each deformation of a surface, and computation of the surface matching function. The present method provides a new 3D morphing technique.

2. The present method avoids problems of multiple mapping and surface overlapping during the morphing process and constructs 3D surface matching function by one-to-one and onto Riemann mapping.

3. The present method uses cubic spline homotopy that applies cubic spline interpolation to a time variable of each deformation of the surface to ensure smooth and natural transformation during the 3D morphing process and generate a plurality of smooth deformable surfaces for creating 3D animation of facial expressions.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A 3D surface morphing method based on conformal parameterization for creation of 3D animation of facial expressions comprising the steps of:
step 1: preparing a first 3-dimensional human face and a second 3-dimensional human face;
step 2: preparing a first unit disk and a second unit disk corresponding to the first human face and the second human face respectively; wherein the first unit disk and the second unit disk are in a two-dimensional surface form;
step 3: using a first mapping unit to map the first human face and the second human face to the first unit disk and the second unit disk respectively;
step 4: using a matching module to construct a surface matching function between the first unit disk and the second unit disk;
step 5: using a second mapping module to map the surface matching function for getting a 3-dimensional (3D) matching function that shows correspondence between the first human face and the second human face; and
step 6: using an interpolation module to compute the 3D matching function multiple times for getting a plurality of smooth deformable surfaces between the first human face and the second human face.

2. The method as claimed in claim 1, wherein the first mapping unit maps the first human face and the second human face to the first unit disk and the second unit disk respectively by using Riemann mapping.

3. The method as claimed in claim 1, wherein the matching module constructs the surface matching function between the first unit disk and the second unit disk by using spline matching.

4. The method as claimed in claim 1, wherein the second mapping module maps in an inverse way compared to the first mapping module so that the surface matching function is inversely mapped to get the 3D matching function between the first human face and the second human face by the second mapping module.

5. The method as claimed in claim 1, wherein the interpolation module gets the smooth deformable surfaces by using cubic spline homotopy.

6. The method as claimed in claim 5, wherein the cubic spline homotopy is application of cubic spline interpolation to a time variable of each deformation of the first human face and the second human face.
